(19) United States
(12) Patent Application Publication
(10) Pub. No.: US 2026/0132833 A1
(43) Pub. Date: May 14, 2026

(54) Disc Brake for a Utility Vehicle

(71) Applicant: KNORR-BREMSE Systeme fuer Nutzfahrzeuge GmbH, Muenchen (DE)

(72) Inventors: Frederic SCHROEPF, Deggendorf (DE); Markus MOLNAR, Fuerstenzell (DE); Stefan HABERL, Osterhofen (DE)

(21) Appl. No.: 19/116,603

(22) PCT Filed: Sep. 22, 2023
(86) PCT No.: PCT/EP2023/076260

§ 371 Date: Mar. 28, 2025

(30) Foreign Application Priority Data
Sep. 30, 2022 (DE) 10 2022 125 261.2

(51) Int. Cl. F16D 65/56; F16D 55/2255; F16D 65/18

(52) U.S. Cl. CPC F16D 65/568; F16D 55/2255; F16D 65/18

(57) ABSTRACT

A disc brake for a utility vehicle has a brake caliper overlapping a brake disc. An application device is arranged in the brake caliper and has a brake lever. At least one adjusting spindle is moveable axially by the application device. An adjusting device is located in the caliper and can be actuated by the brake lever, wherein a wear-related change in a clearance between the brake pad and the brake disc can be substantially compensated by the an axial adjustment of the adjusting spindle. The adjusting device has at least one driver finger which is arranged on the brake lever, extends in the swivelling direction of the brake lever and corresponds to a toothed drive element in operative connection with the adjusting spindle for adjustment. The disc brake is designed such that the driver finger has a support region which is convexly curved in longitudinal extent and which, in function, bears against the associated flank of a tooth of the drive element.

### BACKGROUND AND SUMMARY

The invention relates to a disc brake for a utility vehicle and, more particularly, to a disc brake for a utility vehicle having a brake caliper straddling over a brake disc. An application device is arranged in the brake caliper and has a brake lever. At least one adjusting spindle is moveable axially by the application device. An adjusting device is positioned in the brake caliper and can be actuated by the brake lever, wherein a wear-induced change in a release clearance between the brake pad and the brake disc can be substantially compensated by way of an axial adjustment of the adjusting spindle.

The adjusting device of such a disc brake known, for example, from DE 10 2017 125 867 B4, is used to compensate for a wear-induced change in a release clearance, i.e. the distance between the application-side brake pad and a vehicle-side brake pad.

Here, when a brake lever is actuated, there is an axial adjustment of at least one adjusting spindle, which acts as a brake plunger and is held rotatably in a disc brake bridge that can be moved in the direction of the brake disc during braking.

To rotate the adjusting spindle, there are driver fingers arranged on the brake lever, and these engage in a shift fork of the adjusting spindle, said fork forming an output element, such that, when the brake lever performs a pivoting movement, the shift fork is rotated.

In the event that the release clearance is greater than specified, a correction of the release clearance is accomplished by rotating the adjusting spindle.

As soon as the specified release clearance has been set, there is no further adjustment, for which purpose the adjusting spindle has a ball-ramp clutch of the kind disclosed, for example, in DE 10 2014 113 826 B4.

The geometry of the driver fingers of the known adjusting device is determined primarily by manufacturing requirements, in particular good suitability for production.

However, it has been found that in this case the respective contact region of the driver fingers with the flank of an associated tooth of the shift fork is subject to severe wear since there is only point contact. However, the severe wear leads to the impossibility of complying with the specified release clearance limit, and this ultimately compromises the operational safety of the disc brake overall.

A disc brake of the type in question is likewise the subject of DE 42 04 307 A1. In order to reduce the wear between the driver finger and the output element, the above document proposes to bring two driver fingers into engagement with the tooth gaps of the output element, wherein, to further reduce wear, hardening of the teeth of the output element and of the driver fingers is envisaged.

Apart from the relatively high manufacturing outlay this involves, the problem of high surface pressure is not solved since the driver fingers, which are designed as cylindrical pins, make point contact with the associated flanks of the teeth of the output element.

Moreover, the load reversal requirements in a more modern generation of brakes are significantly higher, to the extent that the known disc brake cannot meet these requirements to the required degree.

The known disc brakes of the type in question cannot satisfy these conditions owing to the abovementioned high point load on the surfaces.

The invention is based on the object of further developing a disc brake of the type in question in such a way that its service life, in particular that of the adjusting device, is improved with little outlay in terms of manufacture.

This object is achieved by a disc brake having the features of the independent claim(s).

In contrast to the prior art, in which, as mentioned, point loading occurs during the operation of the adjuster between the associated flank of the tooth of the output element and the abutting driver finger, linear contact with the flank of the abutting tooth of the output element is achieved by means of the configuration according to the invention of the driver finger, leading to a reduction in the surface pressure with a reduction in wear, i.e. an increase in service life.

The reduced abrasion leads to the release clearance changing only minimally or not at all, and the defined limits not being exceeded, over the predetermined life.

Where two driver fingers aligned in the same direction are provided, the configuration according to the invention enables the transition between the two driver fingers to be optimized, leading to a steady adjustment process, wherein both driver fingers are of substantially the same design.

The new adjusting device is produced in substantially the same way as the known adjusting device, wherein the convex contour of the driver finger preferably occurs only in the region which is relevant to the release clearance. That is to say that the kinematics of the brake remain unchanged.

The adjusting device according to the invention can be provided both on an axial disc brake and on a radial disc brake.

According to another aspect of the invention, the supporting region, which rests against the flank of the associated tooth during operation, is also arched transversely to the longitudinal extent, resulting in linear contact with the flank. However, it is also possible to achieve surface contact by an appropriate cross-sectional contour.

Further advantageous embodiments of the invention are characterized in the dependent claims.

Exemplary embodiments of the invention are described below with reference to the attached drawings.

### BRIEF DESCRIPTION OF THE DRAWINGS

FIG. 1 shows a section of a disc brake according to an embodiment of the invention in a perspective front view;

FIG. 2 shows part of an adjusting device of the disc brake in a diagrammatic depiction;

FIG. 3 shows part of an adjusting device in the operating position in a front view; and

FIGS. 4 and 5a and 5b each show part of the disc brake according to an embodiment of the invention, likewise in a perspective view.

### DETAILED DESCRIPTION OF THE DRAWINGS

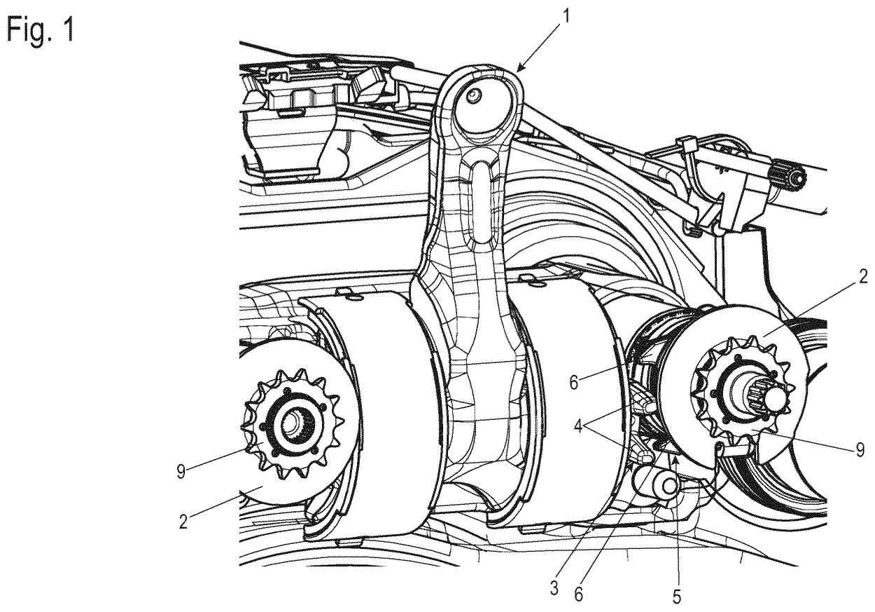

FIG. 1 illustrates part of a disc brake having a brake lever 1, which is a component part of an application device of an axial disc brake, by means of which a brake pad (not illustrated) can be pressed against a brake disc of the utility vehicle.

By means of the brake lever 1, two adjusting spindles 2, each forming a brake plunger, can be moved axially, wherein they are pressed against the brake pad when the brake lever 1 is actuated.

Arranged in a brake caliper accommodating the application device is an adjusting device 3, which can be actuated by the brake lever 1 and with which a wear-induced change in a release clearance between the brake pad and the brake disc can be substantially compensated by way of an axial adjustment of the adjusting spindle 2.

In the example, two adjusting spindles 2 are provided, which can be adjusted by means of a synchronizing device, for which purpose each adjusting spindle 2 has chain sprockets 9, which are component parts of a chain drive.

The adjusting device 3 has two driver fingers 4, which are formed integrally on the brake lever 1, extend in the pivoting direction of the brake lever 1 and engage in tooth gaps between teeth 6 of a shift fork 5 forming an output element, which is held in a twist-proof manner on the associated adjusting spindle 2.

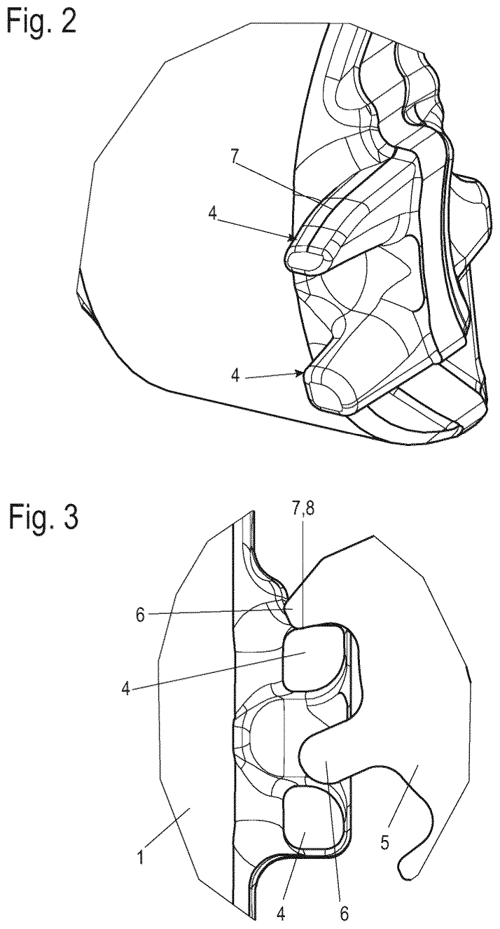

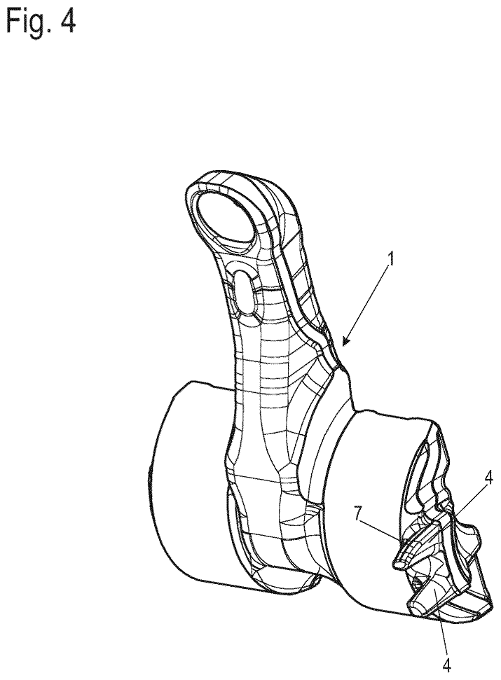

In FIG. 2, it is possible to see the two driver fingers 4 of the adjusting device 3, which, according to the invention, have a supporting region 7, which is convexly arched in the longitudinal extent and which, in operation, as can be seen in FIG. 3, bears against the associated flank 8 of a tooth 6 of the shift fork 5.

It is apparent that the driver finger 4 makes linear contact with the corresponding flank 8 of the shift fork 5 in operation, wherein FIG. 3 represents precisely this position of the upper driver finger 4, in which the shift fork 5 is being rotated clockwise while taking along the adjusting spindle 2.

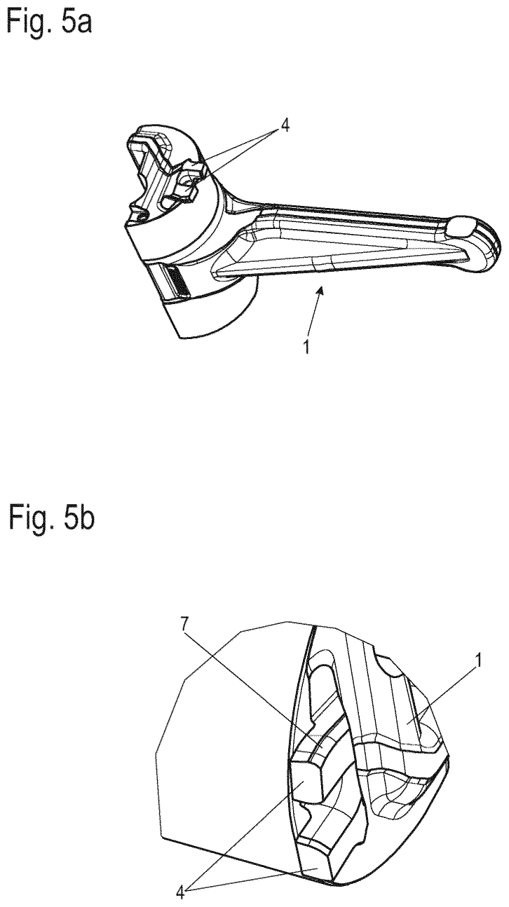

FIG. 4 illustrates the brake lever 1 with connected driver fingers 4 as a detail. Here, this brake lever 1 is designed in such a way that it can be used for an axial disc brake as per the depiction in FIG. 1.

FIG. 5a shows a brake lever 1 for a radial disc brake, on which two driver fingers 4 are likewise arranged on one side. In FIG. 5 a, the brake lever 1 is illustrated as a whole, usually being designed as a casting, while FIG. 5b represents an enlarged detail of the brake lever 1 in the region of the driver fingers 4.

### LIST OF REFERENCE SIGNS

1 brake lever
2 adjusting spindle
3 adjusting device
4 driver finger
5 shift fork
6 tooth
7 supporting region
8 flank
9 chain sprocket

1.-7. (canceled)

8. A disc brake for a utility vehicle, comprising:
a brake caliper configured to straddle over a brake disc;
an application device arranged in the brake caliper and having a brake lever;
at least one adjusting spindle, which is moveable axially by the application device;
an adjusting device positioned in the brake caliper and actuatable by the brake lever, wherein a wear-induced change in a release clearance between a brake pad and the brake disc can be substantially compensated by way of an axial adjustment of the adjusting spindle,
wherein the adjusting device has at least one driver finger, which is arranged on the brake lever, extends in a pivoting direction of the brake lever and, for adjustment, corresponds to a toothed drive element in operative connection with the adjusting spindle,
wherein the driver finger has a supporting region, which is convexly arched in a longitudinal extent and which, in operation, bears against an associated flank of a tooth of the drive element.

9. The disc brake as claimed in claim 8, wherein
a plurality of driver fingers are provided, each driver finger having a convexly arched supporting region.

10. The disc brake as claimed in claim 9, wherein
the convexly arched supporting region is contoured in an arched manner in cross section.

11. The disc brake as claimed in claim 9, wherein
the convexly arched supporting region extends over an entire length of the driver finger.

12. The disc brake as claimed in claim 9, wherein
the convexly arched supporting region extends only over a region of contact with the flank of the tooth.

13. The disc brake as claimed in claim 9, wherein
the convexly arched supporting region makes linear contact with the flank of the tooth.

14. The disc brake as claimed in claim 9, wherein
the convexly arched supporting region makes surface contact with the flank of the tooth.
